(19) United States
(12) Patent Application Publication
(10) Pub. No.: US 2013/0136439 A1
(43) Pub. Date: May 30, 2013

(54) FOCUSING MECHANISM AND IMAGE PICKUP DEVICE USING THE SAME

(71) Applicant: Hong-Bin KOH, New Taipei City (TW)

(72) Inventor: Hong-Bin KOH, New Taipei City (TW)

(21) Appl. No.: 13/408,895

(22) Filed: Feb. 29, 2012

(30) Foreign Application Priority Data
Nov. 24, 2011 (TW) 100143058

(51) Int. Cl. G03B 13/34; G02B 7/04; G03B 13/32

(52) U.S. Cl. 396/144; 396/133; 359/823

(57) ABSTRACT

This invention discloses a focusing mechanism and an image pickup device using the same. The focusing mechanism comprises a driving barrel and a focusing lens-barrel. The driving barrel is a hollow barrel structure having at least three direction convex dots formed in an opening at an end of the driving barrel and extending towards the axial center of the driving barrel. The focusing lens-barrel is a hollow barrel structure disposed in the driving barrel and having at least three barrel grooves formed on an external wall of the focusing lens-barrel and corresponding to the at least three direction convex dots respectively. Each direction convex dot is inserted into its respective barrel groove. When the driving barrel is rotated, the at least three barrel grooves of the focusing lens-barrel are towed by the at least direction convex dots to axially move the focusing lens-barrel in the driving barrel.

### CROSS-REFERENCE TO RELATED APPLICATION

This application claims the benefit of Taiwan Patent Application No. 100143058, filed on Nov. 24, 2011, in the Taiwan Intellectual Property Office, the disclosure of which is incorporated herein in its entirety by reference.

### BACKGROUND OF THE INVENTION

1. Field of the Invention

The present invention relates to a focusing mechanism and an image pickup device using the same, in particular to the focusing mechanism and the image pickup device using at least three direction convex dots and at least three barrel grooves to improve the tilted problem of a focus lens-barrel.

2. Description of the Related Art

As the digital age arrives, the way of recording our life is changing accordingly; as the science and technology advance, digital cameras have become a necessary 3C product of our life. For activities including tourism, exhibition or party gatherings, everybody always carries a digital camera to record good moments. Present existing cameras generally come with a focusing functions, but the focusing of most cameras adopts two vertical columns to achieve the focusing function in a focus mode, and one of the two vertical columns is used for fixing the freedom of a focus lens group on an optical axis, so that the vertical column can adjust the distance of the image sensor from the focus lens group along the optical axis, and the other vertical column is used for of away from the focus lens group or near image sensor; and the other a column for adjusting the angle by using the optical axis as a center point, so as to complete the focusing.

However, the focus lens group is generally fixed to the two vertical columns by a method of suspending arms and installed in the image pickup device, so that after the assembling is completed, it is difficult to change the angle of the focus lens group and the optical axis or the image plane of the image sensor, and it is necessary to require higher precision and technique for the assembling. If the focusing accuracy is found to be poor after the assembling and inspection processes are completed, it takes much effort to disassemble the image pickup device first before adjusting the focus. Furthermore, the suspending arm is used as a fixed supporting point. If the image pickup device is dropped or hit accidentally during its use, the suspending arm may be deformed or shifted to result in an abnormal focusing precision after the factory default settings are calibrated. Under the strict requirements on manufacturing time, cost, and focusing precision, the conventional focusing mechanism is undoubtedly a major obstacle of the development of image pickup devices.

In view of the description above, the inventor of the present invention designed a focusing mechanism and an image pickup device using the same to overcome the drawbacks of the prior art and enhances the industrial applications.

### SUMMARY OF TILE INVENTION

In view of the aforementioned problems of the prior art, it is a primary objective of the present invention to provide a focusing mechanism and an image pickup device using the same to overcome the problems of the prior art using suspending arms to fix on two vertical columns and having difficulties to adjust the focus accurately and maintain a normal focusing due to external forces.

To achieve the aforementioned objective, the present invention provides a focusing mechanism, comprising a driving barrel and a focus lens-barrel. Wherein, the driving barrel is a hollow and barrel-shaped structure having at least three direction convex dots disposed at an opening at one end of the driving barrel and extending towards the axial center of the driving barrel. The focus lens-barrel is a hollow and barrel-shaped structure installed in the driving barrel, and having at least three barrel grooves disposed on an external wall of the focus lens-barrel and corresponding to the at least three direction convex dots respectively, and the at least three direction convex dots are inserted into the at least three barrel grooves respectively, such that when the driving barrel is rotated, the at least three barrel grooves of the focus lens-barrel are towed by the at least three direction convex dots to axially move the focus lens-barrel in the driving barrel to achieve the focusing effect.

Wherein, the at least three direction convex dots may be connected to the center of the driving barrel to form an imaginary straight line respectively, and an included angles between the imaginary straight lines is greater than 30 degrees.

Wherein, distances between at least three direction convex dots may have the same distance from the opening of the driving barrel are equal to each other.

Wherein, the focus mechanism may further comprise a driving module, and the driving barrel has a driving part disposed at the external periphery of the driving barrel, and the driving module is embedded into the driving part of the driving barrel.

Wherein, the at least three barrel grooves of the focus lens-barrel may be towed by the at least three direction convex dots of the driving barrel so as to drive the focus lens-barrel to move axially for focusing when the driving module drives the driving barrel to rotate.

To achieve the aforementioned objective, the present invention provides an image pickup device using the focusing mechanism, and the image pickup device comprises an image sensor and a focusing mechanism. Wherein, the image sensor is installed in the image pickup device. The focusing mechanism comprises a driving barrel and a focus lens-barrel.

The driving barrel has at least three direction convex dots disposed at an opening at one end of the driving barrel and extending towards the axial center of the driving barrel. The focus lens-barrel is a hollow and barrel-shaped structure installed in the driving barrel and having at least three barrel grooves disposed on an external wall of the focus lens-barrel and corresponding to the at least three direction convex dots respectively. The at least three direction convex dots are inserted into the at least three barrel grooves respectively, such that when the driving barrel is rotated, the at least three barrel grooves of the focus lens-barrel are towed by the at least three direction convex dots to axially move the focus lens-barrel in the driving barrel for focusing at the image sensor and forming an image.

Wherein, the at least three direction convex dots may be connected to the center of the driving barrel respectively to form an imaginary straight line, and an included angles between the imaginary straight lines are greater than 30 degrees.

Wherein, the distances, in the optical axis direction, between the at least three direction convex dots and the image sensor may be equal to each other.

Wherein, the image pickup device may further comprise a driving module, and the driving barrel having a driving part disposed at the external periphery of the driving barrel, and the driving module being embedded into the driving part of the driving barrel.

Wherein, the at least three barrel grooves of the focus lens-barrel may be towed by the at least three direction convex dots of the driving barrel so as to drive the focus lens-barrel to move axially along the optical axis and with respect to the image sensor for focusing when the driving module drives the driving barrel to rotate.

In summation of the description above, the focusing mechanism and the image pickup device using the same in accordance with the present invention have one or more of the following advantages:

(1) In the focusing mechanism and the image pickup device using the focusing mechanism, at least three direction convex dots formed on the driving barrel are inserted into at least three barrel grooves of the focus lens-barrel respectively to improve the structural strength of the focusing mechanism.

(2) In the focusing mechanism and the image pickup device using the focusing mechanism, at least three direction convex dots formed on the driving barrel are inserted into at least three barrel grooves of the focus lens-barrel respectively to improve the stability of moving the focusing mechanism axially.

(3) In the focusing mechanism and the image pickup device using the focusing mechanism, at least three direction convex dots are formed on the same plane to improve the tilted problem of the focusing mechanism.

### BRIEF DESCRIPTION OF THE DRAWINGS

FIG. 1 is an exploded view of a focusing mechanism in accordance with a first preferred embodiment of the present invention;

FIG. 2 is a schematic view of a lens of a focusing mechanism in accordance with the first preferred embodiment of the present invention;

FIG. 3 is a schematic view of a direction convex point of a focusing mechanism in accordance with the present invention;

FIG. 4 is a first schematic view of a focusing mechanism in accordance with a second preferred embodiment of the present invention;

FIG. 5 is a second schematic view of a focusing mechanism in accordance with the second preferred embodiment of the present invention; and

FIG. 6 is a schematic view of an image pickup device of a focusing mechanism in accordance with the present invention.

### DESCRIPTION OF THE PREFERRED EMBODIMENTS

The technical characteristics of the present invention will become clear with the detailed description of the preferred embodiments accompanied with the illustration of related drawings as follows. It is noteworthy to point out that the drawings are provided for the purpose of illustrating the present invention, but they are not necessarily drawn according to the actual scale, or are intended for limiting the scope of the invention.

The focusing mechanism of the present invention primarily inserts at least three direction convex dots of the driving barrel into at least three barrel grooves of the focus lens-barrel respectively to improve the structural strength and the tilted problem of the conventional focusing mechanism, so that the focusing mechanism of the invention can be applicable in an image pickup device such as a digital camera, camera phone, a Smartphone, a digital single-lens reflex camera or a digital video camera. Of course, the application of the invention is not limited to such image pickup devices only.

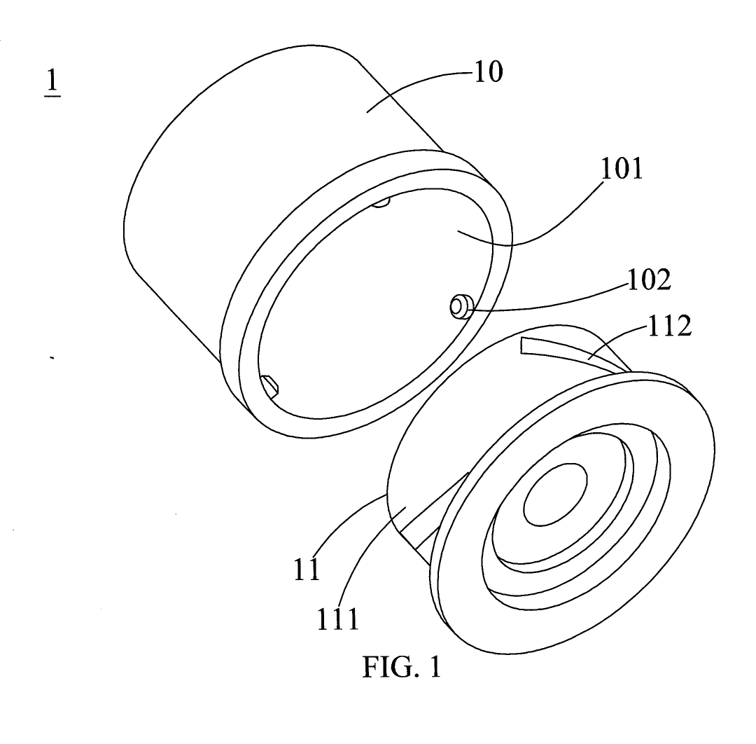

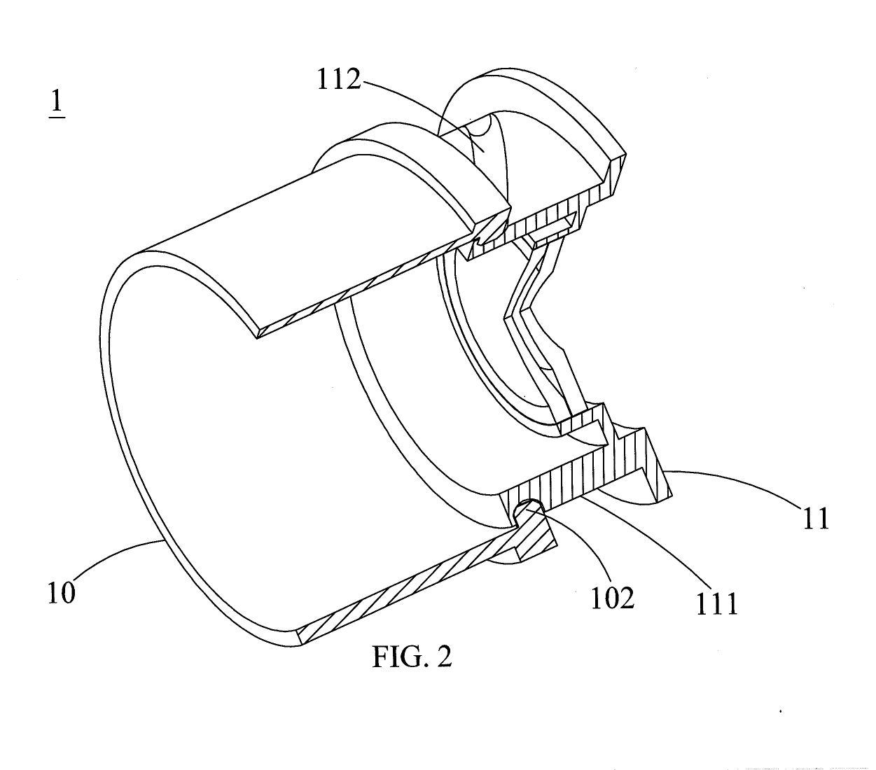

With reference to FIGS. 1 and 2 for an exploded view and a schematic view of a focusing mechanism in accordance with the first preferred embodiment of the present invention respectively, the focusing mechanism 1 comprises a driving barrel 10 and a focus lens-barrel 11. The driving barrel 10 is a hollow and barrel-shaped structure. The driving barrel 10 includes at least three direction convex dots 102 formed in an opening 101 at one end of the driving barrel 10 and extending towards the axial center of the driving barrel 10. The focus lens-barrel 11 is a hollow and barrel-shaped structure disposed in the driving barrel 10, and having at least three barrel grooves 112 formed on an external wall 111 of the focus lens-barrel 11 and corresponding to the at least three direction convex dots 102, and the at least three direction convex dots 102 are inserted into the at least three barrel grooves 112 respectively.

When the driving barrel 10 is rotated clockwise or counterclockwise, the at least three direction convex dots 102 of the driving barrel 10 are inserted into the at least three barrel grooves 112 of the focus lens-barrel 11 respectively, so that the at least three barrel grooves 112 of the focus lens-barrel 11 are towed by the at least three direction convex dots 102 to axially move the focus lens-barrel 11 in the driving barrel 10 for focusing. It is noteworthy to point out that the axial movement of the focus lens-barrel 11 refers to a movement of the focus lens-barrel 11 along the optical axis. In other words, the distance between the focus lens-barrel 11 and an image sensor of the image pickup device is increased or decreased to adjust the distance between the focus lens-barrel 11 and the image sensor appropriately, so that the light of an image of an object to be photographed can be focused precisely on the image sensor.

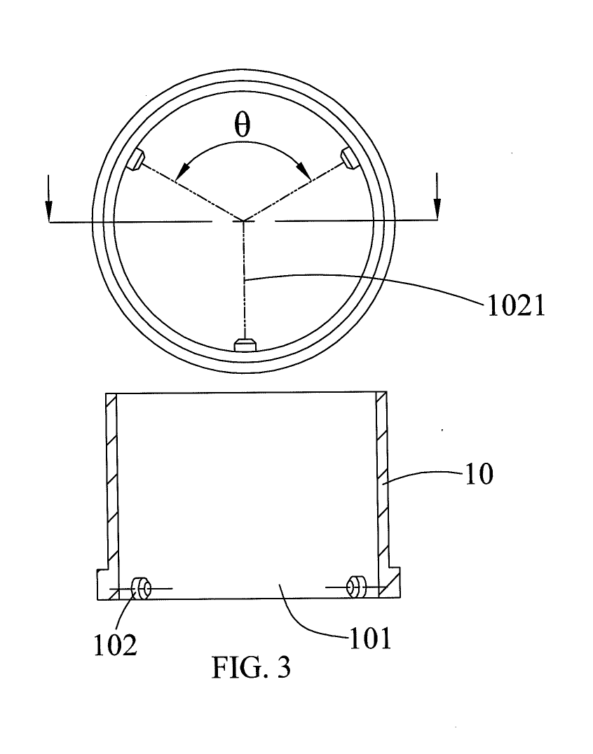

With reference to FIG. 3 for a schematic view of a direction convex point of a focusing mechanism in accordance with the present invention, the at least three direction convex dots 102 are connected to the center of the driving barrel 10 respectively to from an imaginary straight line 1021, and the included angle between the imaginary straight lines 1021, θ, is greater than 30 degrees, and the distances between the at least three direction convex dots 1021 and the opening 101 of the driving barrel 10 are equal to each other. Wherein, if the quantity of direction convex dots 102 is equal to three, the connection of the three direction convex points 102 constitutes an imaginary plane, and the included angle between the imaginary straight lines 1021, θ, is greater than 30 degrees, so that the driving barrel 10 in the focus lens-barrel 11 can be moved axially and stably. More specifically, the included angle between the imaginary straight lines 1021 of the three direction convex points 102 is greater than 30 degrees, so that the three direction convex points 102 can be distributed more uniformly on the external wall 111 of the focus lens-barrel 11 to form an imaginary plane. In this way, the three barrel grooves 112 of the focus lens-barrel 11 are towed by the three direction convex points 102, and three positions of the focus lens-barrel 11 are pushed simultaneously to produce a more uniform pushing force to achieve the effects of moving the focus lens-barrel 11 in the driving barrel 10 axially and stably, and providing a more secured structure for bearing impact forces when the focusing mechanism or the image pickup device is collided.

If there is only one direction convex point 102, only one position of the focus lens-barrel 11 is pushed, such that the focus lens-barrel 11 may be biased to a side in the driving barrel 10 to result in an unsmooth focusing operation. Even worse, the focus lens-barrel 11 may be stuck at the driving barrel 10 to cause to fail to focus. Similarly, if the quantity of direction convex point 102 is equal to two, the pushing force for axially moving the focus lens-barrel 11 is still non-uniform that may cause an unsmooth focusing operation. Therefore, the quantity of direction convex points 102 and the quantity of corresponding barrel grooves 112 are preferably at least three. In practical application, if each included angle between the imaginary straight lines 1021 is greater than 30 degrees and the designed space can accommodate four, five or more direction convex points 102 to obtain more uniform pushing force, the focus lens-barrel 11 can be moved axially and more stably. However, the quantity of direction convex points 102 adopted in this preferred embodiment is used for illustrating the present invention, but not intended for limiting the scope of the invention.

If the distance between each direction convex point 1021 and the opening 101 of the driving barrel 10 is equal to each other, the axial center line of the focus lens-barrel 11 is parallel to the axial center line of the driving barrel 10. If the focusing mechanism 1 is assembled to the image pickup device, the tilt adjustment of the focus lens-barrel 11 is finished to improve the tilted problem of the focusing mechanism 1 and achieve the effect of saving the assembling time. In the actual production, there may be a slight error of the distance between each direction convex point 1021 and the opening 101 of the driving barrel 10, but the inclination of focusing mechanism 1 can be maintained to be less than 0.1 degree under a general design error requirement.

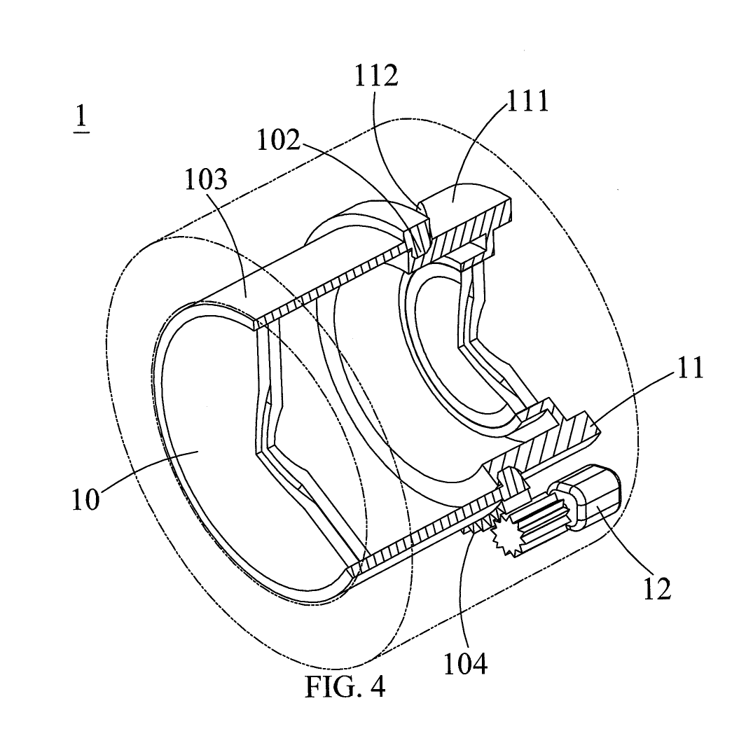

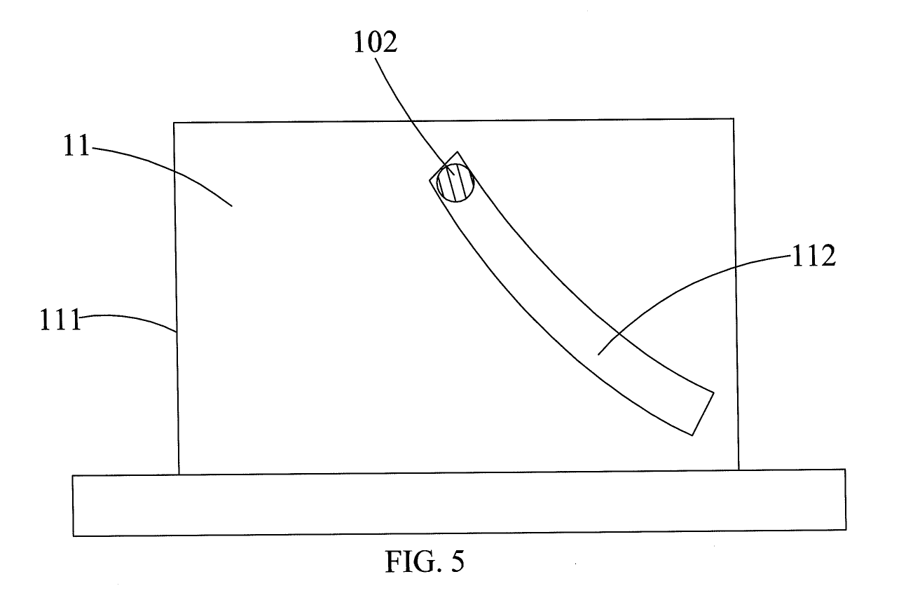

With reference to FIGS. 4 and 5 for first and second schematic view 5 of a focusing mechanism in accordance with the second preferred embodiment of the present invention respectively, the connection and operation of the focusing mechanism 1 is the same as the first preferred embodiment, and thus will not be described again. In FIGS. 4 and 5, the focusing mechanism 1 further comprises a driving module 12, and the driving barrel 10 has a driving part 104 disposed at the external periphery 103 of the driving barrel 10 and the driving module 12 is embedded into the driving part 104 of the driving barrel 10. Wherein, the barrel groove 112 of the focus lens-barrel 11 can be an oblique groove or a combination of a linear groove and an oblique groove. If the driving module 12 drives the driving barrel 10 to rotate clockwise or counterclockwise, and each direction convex point 102 of the driving barrel 10 is disposed in each barrel groove 112 of the focus lens-barrel 11, each direction convex point 102 abuts a side of the internal wall of each barrel groove 112. Each direction convex point 102 of the driving barrel 10 tows each respective barrel groove of the focus lens-barrel to move the focus lens-barrel 10 axially for focusing. Wherein, the driving module 12 is installed in the focusing mechanism 1 or the image pickup device for driving the driving barrel 10 to rotate clockwise or counterclockwise, and the driving module 12 can be a DC motor or a stepper motor, and a control module (not shown in the figure) is further provided for controlling the operation of the motor, so as to drive the driving barrel 10 clockwise or counterclockwise for a zooming operation.

In FIG. 5, the direction convex point 102 abuts an internal wall of the oblique groove portion of the barrel groove 112 of the focus lens-barrel 11, so that when the driving barrel 10 is rotated clockwise, the internal sidewall of the barrel groove 112 is an oblique surface, the barrel groove 112 climbs along the direction convex points 102 to move the focus lens-barrel 12 axially into the driving barrel 10 to drive the focus lens-barrel 11 to move. Similarly, when the driving barrel 10 is rotated in a reverse direction, the barrel groove 112 is moved downwardly along the direction convex points 102, so that the focus lens-barrel 12 is moved axially and gradually to the driving barrel 10, and an end of the focus lens-barrel 12 is exposed from the driving barrel 10.

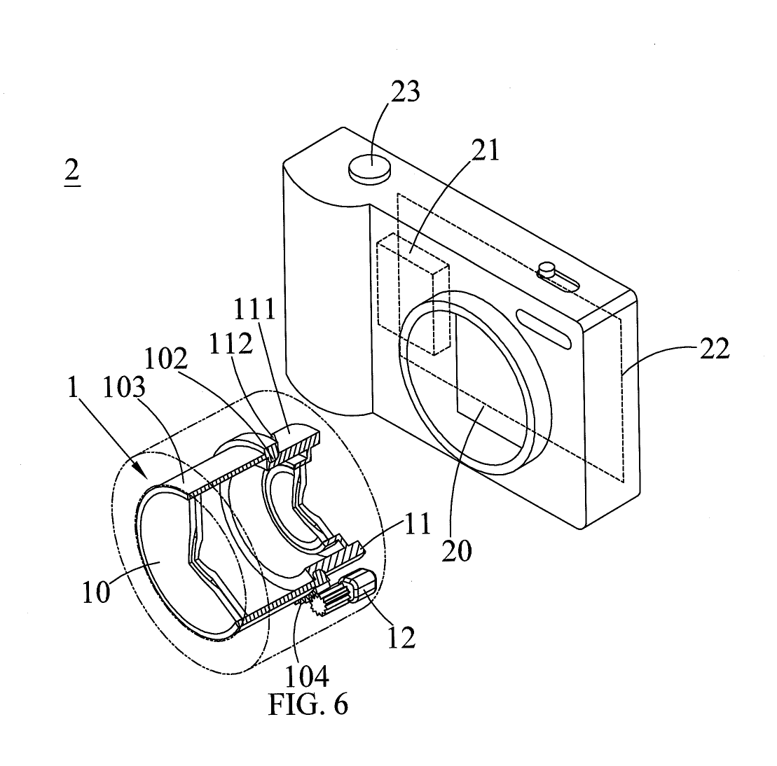

With reference to FIG. 6 for a schematic view of an image pickup device of a focusing mechanism in accordance with the present invention, the focusing mechanism 1 is applied to the image pickup device 2. The image pickup device 2 comprises a focusing mechanism 1, a driving module 12, an image sensor 20, a control module 21, a display module 22 and a plurality of control buttons 23, wherein the connection and operation of the of this preferred embodiment are the same as those described above, and thus will not be described again. The driving module 12 is installed in the focusing mechanism 1 or the image pickup device 2. The image sensor 20 is installed in the image pickup device 2. The image sensor 20 can be a charge coupled device (CCD) or a complementary metal oxide semiconductor (CMOS) sensor for sensing the light of an image of an object to be photographed. The control module 21 is installed in the image pickup device 2 and electrically coupled to the driving module 12 to control the operation of the driving module 12, and the control module 21 can be a microprocessor control unit, a central processing unit (CPU) or a micro-processing unit. The display module 22 can be a liquid crystal display (LCD) or a touch LCD screen, and the display module 22 is installed at the exterior of the image pickup device 2 and electrically coupled to the image sensor 20 for displaying an image. The control buttons 23 are installed at the exterior of the image pickup device 2 and electrically coupled to the control module 21.

If a user presses one of the control buttons 23 of the image pickup device 2, the control module 21 controls the operation of the driving module 12 to drive the driving barrel 10 to rotate. When the driving barrel 10 is rotated, the focus lens-barrel 11 is moved axially to adjust the distance between the focus lens-barrel 11 and the image sensor 20 appropriately to focus the light of an image of an object to be photographed onto an image plane of the image sensor 20, form an image of the object to be photograph, and display the image from the display module 22 to complete the focusing operation.

When the driving barrel 10 is rotated clockwise or counterclockwise, the three direction convex points 102 of the driving barrel 10 are inserted into the three barrel grooves 112 of the focus lens-barrel 11, such that the oblique groove portion of the three barrel grooves 112 of the focus lens-barrel 11 is towed by the three direction convex points 102 to drive the focus lens-barrel 11 to move along the optical axis and with respect to the image sensor 20, so as to adjust the distance appropriately and focus the light of an image of an object to be photographed on an image plane of the image sensor 20 to form an image of the object to be photographed. It is noteworthy to point out that the distance of each direction convex point 112 from the optical axis is the same as the distance of the image sensor 20 from the optical axis, so that the lens in the focus lens-barrel 11 is aligned in parallel to the image plane of the image sensor 20 to achieve the effect of improving the tilted problem of the focusing mechanism 1.

In summation of the description above, the focusing mechanism and the image pickup device can insert at least three direction convex dots of the driving barrel into at least three barrel grooves of the focus lens-barrel to secure the focus lens-barrel. Even if the focusing mechanism and the image pickup device are collided with a compact force, their factory default settings of the structure and focus calibration can be maintained. In the focusing mechanism and the image pickup device, at least three direction convex dots of the driving barrel are inserted into at least three barrel grooves of the focus lens-barrel, and at least three direction convex dots are connected the center of the driving barrel respectively to form an imaginary straight line, and the included angle between the imaginary straight lines is greater than 30 degrees, so that the focus lens-barrel is pushed by the driving barrel with a more uniform force to improve the stability of moving the focusing mechanism axially. In addition, the focusing mechanism and at least three direction convex dots of the image pickup device are disposed on the same imaginary plane, so that the imaginary plane can be parallel to a distal surface of the driving barrel or the image plane of the image sensor, so as to improve the problem of a tilted focusing mechanism.

What is claimed is:

1. A focusing mechanism, comprising:
a driving barrel, being a hollow and barrel-shaped structure, and having at least three direction convex dots disposed at an opening of one end of the driving barrel and extending towards the axial center of the driving barrel; and
a focus lens-barrel, being a hollow and barrel-shaped structure, installed in the driving barrel, and having at least three barrel grooves disposed on an external wall of the focus lens-barrel and corresponding to the at least three direction convex dots respectively, and the at least three direction convex dots being inserted into the at least three barrel grooves respectively, such that when the driving barrel is rotated, the at least three barrel grooves of the focus lens-barrel are towed by the at least three direction convex dots to axially move the focus lens-barrel in the driving barrel.

2. The focusing mechanism of claim 1, wherein the at least three direction convex dots are connected to the center of the driving barrel to form an imaginary straight line respectively, and an included angles between the imaginary straight lines is greater than 30 degrees.

3. The focusing mechanism of claim 1, wherein distances between the at least three direction convex dots and the opening of the driving barrel are equal to each other.

4. The focusing mechanism of claim 1, further comprising a driving module, and the driving barrel having a driving part disposed at the external periphery of the driving barrel, and the driving module being embedded into the driving part of the driving barrel.

5. The focusing mechanism of claim 4, wherein the at least three barrel grooves of the focus lens-barrel are towed by the at least three direction convex dots of the driving barrel so as to drive the focus lens-barrel to move axially for focusing when the driving module drives the driving barrel to rotate.

6. An image pickup device, comprising:
an image sensor, installed in the image pickup device; and
a focusing mechanism, comprising:
a driving barrel, and having at least three direction convex dots disposed at an opening at one end of the driving barrel and extending towards the axial center of the driving barrel; and
a focus lens-barrel, being a hollow and barrel-shaped structure, installed in the driving barrel, and having at least three barrel grooves disposed on an external wall of the focus lens-barrel and corresponding to the at least three direction convex dots respectively, and the at least three direction convex dots being inserted into the at least three barrel grooves respectively, such that when the driving barrel is rotated, the at least three barrel grooves of the focus lens-barrel are towed by the at least three direction convex dots to axially move the focus lens-barrel in the driving barrel for focusing at the image sensor and forming an image.

7. The image pickup device of claim 6, wherein the at least three direction convex dots are connected to the center of the driving barrel respectively to form an imaginary straight line, and the included angles between imaginary straight lines are greater than 30 degrees.

8. The image pickup device of claim 6, wherein the distances, in the optical axis direction, between the at least three direction convex dots and the image sensor are equal to each other.

9. The image pickup device of claim 6, further comprising a driving module, and the driving barrel having a driving part disposed at the external periphery of the driving barrel, and the driving module being embedded into the driving part of the driving barrel.

10. The image pickup device of claim 9, wherein the at least three barrel grooves of the focus lens-barrel are towed by the at least three direction convex dots of the driving barrel so as to drive the focus lens-barrel to move axially along the optical axis and correspondingly to the image sensor for focusing when the driving module drives the driving barrel to rotate.
